(19) United States
(12) Patent Application Publication
(10) Pub. No.: US 2010/0228600 A1
(43) Pub. Date: Sep. 9, 2010

(54) System and method for sponsorship recognition

(76) Inventors: Eric Lempel, Hayward, CA (US); Jennifer Cho, Redwood City, CA (US)

Correspondence Address: FROMMER LAWRENCE & HAUG LLP, 745 FIFTH AVENUE, NEW YORK, NY, 10151, US

(21) Appl. No.: 12/400,502

(22) Filed: Mar. 9, 2009

(51) Int. Cl. G06Q 30/00; G06Q 50/00

(52) U.S. Cl. 705/10; 705/14.4

(57) ABSTRACT

A method and apparatus for providing recognition to individuals and corporations (sponsors) that sponsor electronic content and other products and services, including, for example: video games, CDs, DVDs, movie rentals, game rentals, downloadable content, virtual gaming accessories and other merchandise. Sponsors may associate an icon with sponsored content so that users, such as gamers, who may not be viewing the sponsored content, may see the sponsor's icon and a description of the sponsored content when other gamers are using the sponsored content. Thus, the sponsor may receive recognition for their participation in providing the goods and/or services.

### BACKGROUND

1. Field of the Invention

The present invention relates generally to a system and method for providing recognition to individuals and corporations for sponsoring content to users. More specifically, the present invention is directed to enabling sponsors to associate an icon with sponsored content so that gamers, who may not be viewing the sponsored content, will see the sponsor's icon and a description of the sponsored content.

2. Background Discussion

Typically, sponsorship is a relationship between two parties where both seek benefits through an exchange of products, services or funds. Sponsorships are very popular on the Internet where a corporation will sponsor a website in return for advertising space or a banner when a user visits the sponsored website. In the case of a website, the sponsorship may include banners or buttons on the site, and possibly a tag line. Such sponsorships may include an advertising relationship that typically involves the payment of a fixed fee to display a banner or other graphic on the website. Companies may use sponsorship as a medium to get advertising and commercials to an audience.

### SUMMARY

The present invention is directed to a method and apparatus for providing recognition to individuals and corporations (sponsors) that sponsor electronic content and other products and services, including, for example: video games, CDs, DVDs, movie rentals, game rentals, downloadable content, virtual gaming accessories and other merchandise. Sponsors may associate an icon with sponsored content so that users, such as gamers, who may not be viewing the sponsored content, may see the sponsor's icon and a description of the sponsored content when other gamers have accessed, or are using, the content. Thus, the sponsor may receive recognition for their participation in providing the goods and/or services.

One embodiment of the present invention is directed to a method for displaying sponsorship data on a display unit. The method includes establishing electronic content data and/or articles being sponsored by a third party (e.g., a corporation or advertising party). The sponsored electronic content and/or sponsored articles are associated with the sponsorship data. (The sponsorship data may be an icon that is chosen by the sponsor and may include the sponsor's logo or other identifying information.) The sponsored electronic content data and/or sponsored articles are provided to first users based on predetermined criteria and actions by the first users, and the sponsorship data (e.g., icon or logo) is displayed on a display unit of a second user while the sponsored electronic content and/or sponsored articles is accessed by the first users.

Another embodiment of the present invention is directed to the method described above wherein the sponsorship data is dynamically modified. The modified sponsorship data is displayed on a display unit associated with the second users while the sponsored electronic content and/or sponsored articles are accessed by the first users. Thus, a sponsor may modify the logo or icon.

Yet another embodiment of the present invention is directed to the method described above wherein the sponsored electronic content and/or sponsored articles are dynamically modified and sponsorship data associated with the modified sponsored electronic content and/or sponsored articles is displayed on a display unit associated with the second users while the sponsored electronic content and/or sponsored articles is accessed by the first users.

Yet another embodiment of the present invention is directed to the method described above furthermore providing a link from the displayed sponsorship data to a website related to the sponsor. This permits a viewer to access a website associated with a sponsor.

Yet another embodiment of the present invention is directed to the method described above and furthermore, establishing a fee schedule for each third party to sponsor the electronic content and/or articles.

Yet another embodiment of the present invention is directed to the method described above wherein the sponsored electronic content data and/or sponsored articles includes, for example, video games, virtual articles, down-loadable electronic content, electronic items, demos, plug-ins, CDs DVDs, video rental, audio rental and audio content.

Yet another embodiment of the present invention is directed to the method described above furthermore embedding predetermined content in the sponsored electronic content based on the third party.

Other embodiments of the present invention include the methods described above but implemented using apparatus or programmed as computer code to be executed by one or more processors operating in conjunction with one or more electronic storage media.

### BRIEF DESCRIPTION OF THE DRAWINGS

To the accomplishment of the foregoing and related ends, certain illustrative aspects of the invention are described herein in connection with the following description and the annexed drawings. These aspects are indicative, however, of but a few of the various ways in which the principles of the invention may be employed and the present invention is intended to include all such aspects and their equivalents. Other advantages, embodiments and novel features of the invention may become apparent from the following description of the invention when considered in conjunction with the drawings. The following description, given by way of example, but not intended to limit the invention solely to the specific embodiments described, may best be understood in conjunction with the accompanying drawings, in which:

FIG. 1 illustrates an example of display data showing an example of sponsorship data according to an embodiment of the present invention;

FIG. 2 illustrates an example of a network in which sponsorship data may be generated and displayed according to an embodiment of the present invention;

FIG. 3 illustrates an example of a processing apparatus for generating and displaying sponsorship data according to an embodiment of the present invention;

FIG. 4 shows an example of an algorithm used to generate and display sponsorship data according to an embodiment of the present invention;

FIG. 5 shows an example of display data including sponsorship data according to an embodiment of the present invention; and

FIG. 6 shows an example of display data including another example of sponsorship data according to an embodiment of the present invention.

### DETAILED DESCRIPTION

It is noted that in this disclosure and particularly in the claims and/or paragraphs, terms such as “comprises,” “comprised,” “comprising,” and the like can have the meaning attributed to it in U.S. patent law; that is, they can mean “includes,” “included,” “including,” “including, but not limited to” and the like, and allow for elements not explicitly recited. Terms such as “consisting essentially of” and “consists essentially of” have the meaning ascribed to them in U.S. patent law; that is, they allow for elements not explicitly recited, but exclude elements that are found in the prior art or that affect a basic or novel characteristic of the invention. These and other embodiments are disclosed or are apparent from and encompassed by, the following description. As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

Furthermore, the detailed description describes various embodiments of the present invention for illustration purposes and embodiments of the present invention include the methods described and may be implemented using one or more apparatus, such as processing apparatus coupled to electronic media. Embodiments of the present invention may be stored on an electronic media (electronic memory, RAM, ROM, EEPROM) or programmed as computer code (e.g., source code, object code or any suitable programming language) to be executed by one or more processors operating in conjunction with one or more electronic storage media.

An embodiment of the present invention is directed to including recognition of the source of the content, whether that source is commercial or personal. For instance, content, such as a video game may be given to the user for a promotional event hosted by, for example, Company A, on a portion of the display (for example the Xross-Media bar underneath the Game tab), would be displayed the subtitle “Provided by Company A”, or text of similar meaning, or icon or logo that identifies the sponsoring party (e.g., Company A). Additionally, when the user plays the game content downloaded (for example through a voucher code), he/she would appear as currently playing the game. This sponsorship data could also be displayed on his/her network friends', for example, using an Xross-Media bar Friends List as well. This functionality could also extend to in-game functionality, displaying recognition of the voucher code provider (sponsor) within the video game.

As an example, a sponsoring party, such as a corporation may provide a voucher that may be redeemed, by a user accessing a voucher code, for electronic items, such as content and/or articles. In return for sponsoring the redeemed items, the sponsor is permitted to place sponsorship data associated with the redeemed items. The recognition of a sponsor (a) recognizes the source of the voucher code individually and adapts it into the system, and (b) it is a functionality that is implemented throughout the network instead of only staying within the game content. Thus the sponsored content (e.g., video game) may have in-game advertising for the sponsor's goods and/or services. This provides a sponsor an opportunity to reach the intended audience.

An embodiment of the present invention is that an exact source from which the user received the sponsored content is identified to users other than the user who received/accessed the sponsored content. The content may be, for example, a video game, audio content, plug-in, downloadable content, gaming accessories CDs, DVDs and other sponsored goods and/or services. The content may be purchased by the user, or obtained using a coupon or voucher code from the sponsor. The sponsorship data, or other recognition identifier may be placed within the game or on the network display. The extent to how these sources could be recognized could vary: for example, the recognition may be in-game, a syntax replacement within the credits of the game, or an item that shows the name of the voucher provider. Examples of a network-wide embodiment include displaying the recognition data, or sponsorship data, only to the user at a portion of the display unit such as a picture-in-picture display or, for example, when using a PLAYSTATION® NETWORK underneath the Game tab on the Xross Media bar, or to the user's entire friends list, in the user's profile or on the current game display that shows when scrolling through the Friends List on the Xross Media bar.

The sponsorship data can vary in format, not only being limited to existing in-game, but in the user's PLAYSTATION® NETWORK profile, spreading the word across his/her friends list. Not only will this encourage users to give each other voucher codes (such as a Custom created combination voucher code), but it will also trigger various promotions for varying companies. Users/gamers may also have the option to turn off this functionality, in the case that he/she does not want certain information displaying to their PLAYSTATION® NETWORK friends.

Furthermore, the sponsorship data is not limited for commercial purposes, but that it could also be used for personal gift recognition.

Furthermore, especially in the case of in-game recognition, the inclusion of sponsorship data does not materially change the user's game-play experience. The functionality could be, for example, as replaceable syntax within the game code.

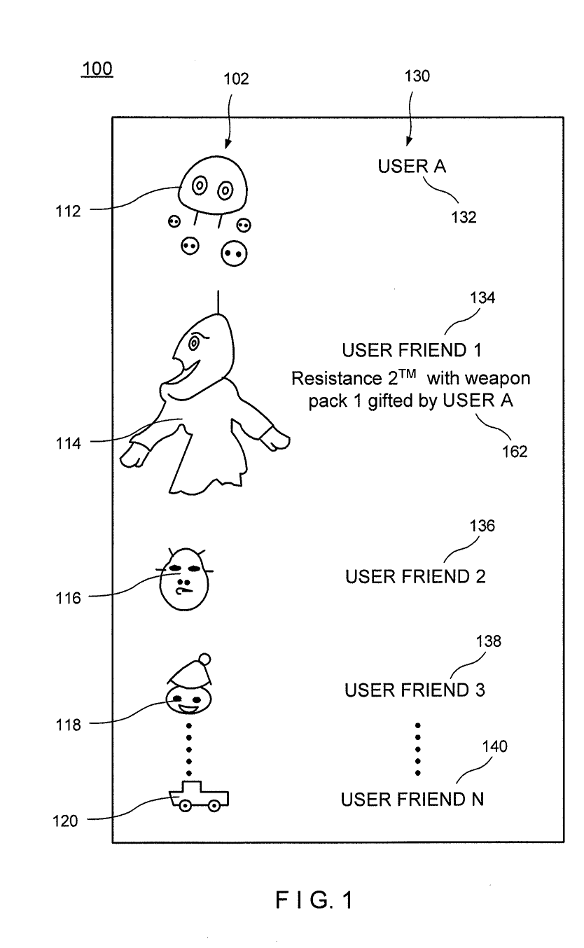

FIG. 1 illustrates an example of display data 100 showing an example of sponsorship data according to an embodiment of the present invention. FIG. 1 illustrates an example of display data 100, which is, for example, a combination of text, graphic and/or audio data that is displayed to a user and may be displayed on a GUI, computer monitor, processor screen of other electronic display apparatus. The display data 100 is typically comprised of pixels and is output using a display apparatus or device. The display data 100 includes a category of icons 102 and a category of users 130.

Category of icons 102 includes icons, or graphical or pictorial representations 112, 114, 116, 118 and 120. These icons are associated with users in user category 130. For example icon 112 is associated with “User A” 132; icon 114 is associated with “User Friend 1” 134; icon 116 is associated with “User Friend 2” 136; icon 118 is associated with “User Friend 3” 138; and icon 140 is associated with “User Friend N” 140 (where “N” is any suitable number).

Thus, User A may be at an associated terminal or device and viewing his/her friends list. The friends of User A are shown as User Friend 1 (134); User Friend 2 (136); and User Friend 3 (138). While three friends, and associated icons, are shown in FIG. 1, User A could have any number of friends on his/her Friends List that may be viewed by scrolling.

As shown by User Friend 1 (134) on User A Friends List, a RESISTANCE2™ with weapon pack 1 is being used by User Friend 1 (134). The RESISTANCE2™ with weapon pack 1 is shown as gifted by User A, as shown by text 162. Text 162 is an example of recognition data or sponsor data that shows one party provided content to another. For example, User A provided the RESISTANCE2™ with weapon pack 1 to User Friend 1 (134). When User Friend 1 is using the item, the use is reflected on User A's Friends List. Thus, User A is able to see that User Friend 1 (134) is utilizing the content (RESISTANCE2™ with weapon pack 1) given by User A. Similarly, any other user who has User Friend 1 (134) on their Friends List will see that User Friend 1 is using the content (RESISTANCE2™ with weapon pack 1) and that it was given, or provided by User A, as indicated by sponsor data 162. Thus, the sponsor data is provided whenever a user is using content sponsored, or provided, by another.

User A may have provided the content (RESISTANCE2™ with weapon pack 1) by giving User Friend 1 a voucher, or the actual item. In either situation, User A is given recognition of the gift by sponsor data 162.

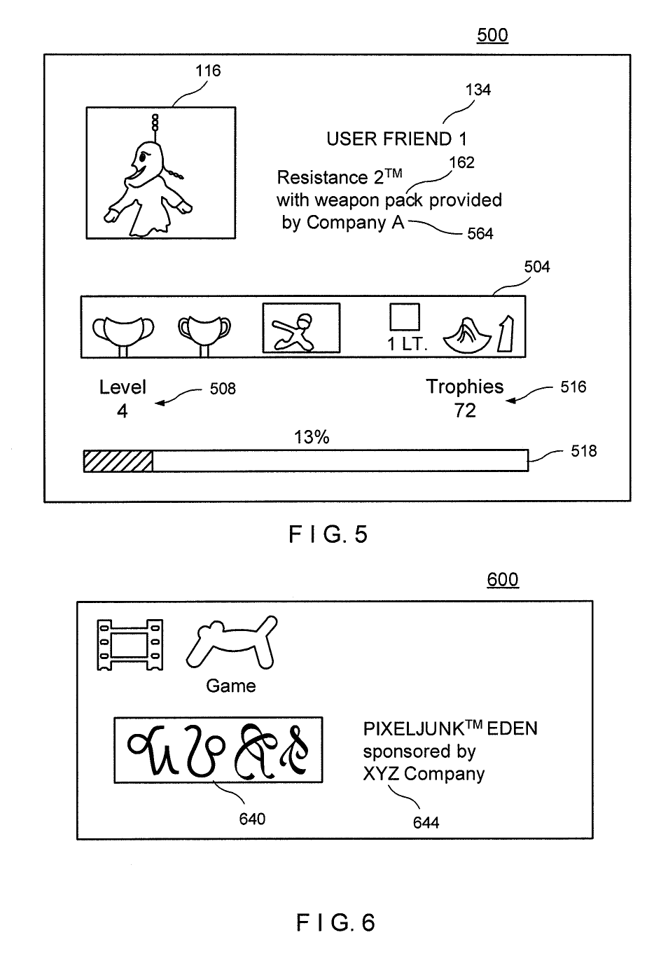

Additional embodiments and features are described in relation to FIGS. 5 and 6 herein.

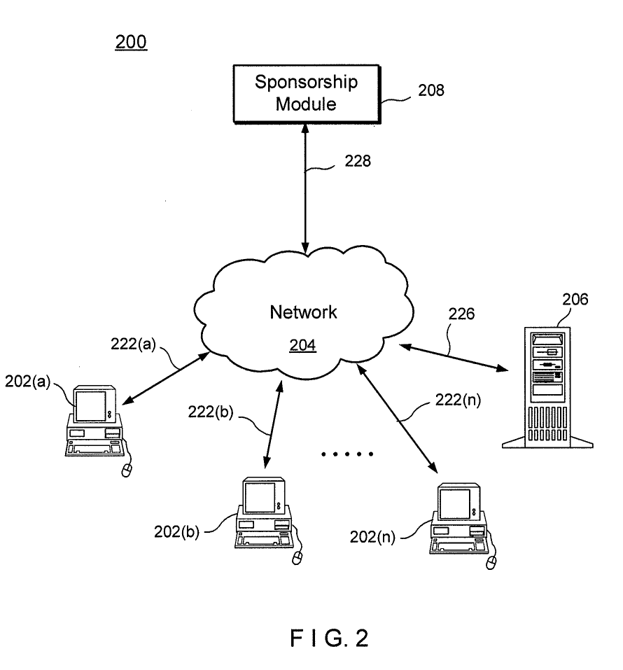

FIG. 2 illustrates an example of a network environment 200 in which sponsorship data may be generated and displayed according to an embodiment of the present invention.

Embodiments of the present invention may be implemented using one or more processing devices, or processing modules. The processing devices, or modules, may be coupled such that portions of the processing and/or data manipulation may be performed at one or more processing devices and shared or transmitted between a plurality of processing devices. For example, a user, or gamer may play against other users, or gamers over the network 200. The data processing may be performed by various module coupled to the network, either as the same unit or at a remote location.

Thus, an example of the invention is described in a network environment. Specifically, FIG. 2 shows a network environment 200 adapted to support various embodiments of the present invention. The exemplary environment 200 includes a network 204, a sponsorship module, or sponsorship facility, 208. (A module, or facility, as used herein, is for example, a series of instructions stored on a computer-readable, or an electronic storage medium storing program code, or a memory unit storing instructions that is coupled to an associated dedicated processing unit for execution of the instructions, the module may be a plug-in unit, stand alone set of instructions, or program code or may be an integral part of a larger component. Each module may be stored in a separate memory or a common computer memory.) FIG. 2 also show a plurality of terminals 202(a) . . . 202(n), where “n” is any suitable number and a kiosk 206.

The network 204 is, for example, any combination of linked computers, or processing devices, adapted to transfer and process data. The network 204 may be private Internet Protocol (IP) networks, as well as public IP networks, such as the Internet that can utilize World Wide Web (www) browsing functionality. An example of a wired network is a network that uses communication busses and MODEMS, or DSL lines, or a local area network (LAN) or a wide area network (WAN) to transmit and receive data between terminals. An example of a wireless network is a wireless LAN. Global System for Mobile Communication (GSM) is another example of a wireless network.

The GSM network is divided into three major systems which are the switching system, the base station system, and the operation and support system (GSM). Also, IEEE 802.11 (Wi-Fi) is a commonly used wireless network in computer systems that enables connection to the Internet or other machines that have Wi-Fi functionality. Wi-Fi networks broadcast radio waves that can be picked up by Wi-Fi receivers that are attached to different computers.

Sponsorship, or sponsor, module, or facility 208 may be for example a server computer operatively connected to network 204, via bi-directional communication channel, or interconnector, 228, which may be for example a serial bus such as IEEE 1394, or other wire or wireless transmission medium. The terms “operatively connected” and “operatively coupled”, as used herein, mean that the elements so connected or coupled are adapted to transmit and/or receive data, or otherwise communicate. The transmission, reception or communication is between the particular elements, and may or may not include other intermediary elements. This connection/coupling may or may not involve additional transmission media, or components, and may be within a single module or device or between the remote modules or devices.

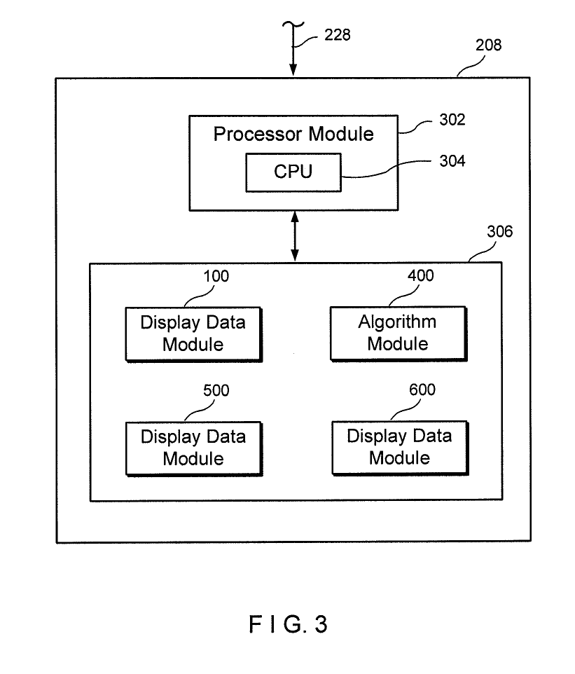

The sponsorship module 208 is adapted to transmit data to, and receive data from, terminals 202(a) . . . (n) and kiosk 206, via the network 204. Sponsorship module 208, which may be a server computer, is described in more detail with reference to FIG. 3, herein.

Terminals 202(a) . . . (n) (where “n” is any suitable number) (generally referred to as 202) are coupled to network 204 via an associated bi-directional communication medium 222(a) . . . (n), which may be for example a serial bus such as IEEE 1394, or other wire or wireless transmission medium. Terminals 202 may be communication appliances, or user locations, or subscriber devices, or client terminals. For example, terminals 202 may be computers, or other processing devices such as a desktop computer, laptop computer, personal digital assistant (PDA), wireless handheld device, PLAYSTATION™, PSP™ PLAYSTATION® NETWORK terminal and the like. They may be capable of processing and storing data themselves or merely capable of accessing processed and stored data from another location (i.e., both thin and fat terminals).

Terminal 202(a) may be a user terminal at which a user sponsors content, and/or uses sponsored content and/or views icons and/or text indicating that another is using sponsored content. Terminal 202(a) may be a home computer or gaming terminal.

Terminal 202(n) may be a terminal at a public location, or available to rent while a user is gaming. Terminal 202 may also be used to communicate with sponsorship module 208 to provide sponsored content and sponsorship data (logos, text, other data identifying the sponsor). Kiosk 206 is also adapted and capable of being used as a gaming terminal and may be for example a PLAYSTATION™ unit adapted to be used by garners at the location of the kiosk. The kiosk 206 may be located at a street corner of a city the gamer is visiting and wishes to play while away from home. Thus, a user may access video content, audio content as well as indications of sponsorship at kiosk 206. The kiosk 206 is coupled to network 204 via bi-directional communication medium 226. The kiosk is similar to functionality of terminals 202 except that it is typically a publically available terminal.

Terminals 202 typically include a display unit and an input unit. The display unit is used to display the data generated by the system 200 as well as input generated at the terminal 202, and the network 204. The display unit of terminal 202 may be, for example, a monitor, LCD (liquid crystal display), a plasma screen, a graphical user interface (GUI) or other unit adapted to display output data typically by a representation of pixels to form text and graphic and video data and/or audio data via associated speakers (speakers not shown). The input unit may include devices such as a keyboard, mouse, track ball and/or touch pad or any combination thereof.

The display unit of terminal 202 may display generated at other components of the network 204. Specifically, data generated at sponsorship module, or sponsorship facility, 208 and other terminals being used by other users may be displayed at the terminal display units.

The sponsorship module 208 and terminals 202 and kiosk 206 typically utilize a network service provider, such as an Internet Service Provider (ISP) or Application Service Provider (ASP) (ISP and ASP are not shown) to access resources of the network 204.

FIG. 3 illustrates an example of a processing apparatus for generating and displaying sponsorship data according to an embodiment of the present invention. FIG. 3 illustrates an example of sponsorship module 208, which is a module (processor, electronic storage medium, program code and electronic data). The sponsorship module 208 includes a processor module 302, a memory module 306, display data module 100, algorithm module 400, data display module 500 and data display module 600. Sponsorship module 208 is coupled to network (204 in FIG. 1) via bi-direction communication medium 228.

Processor module 302 is coupled to memory module 306 via an associated communication link to enable processor module 302 to coordinate processing operations of the modules 100, 400, 500 and 600. These module may be a memory location that may also include a dedicated processor, or may use processor 302 to process the data. The processor module 302 includes a CPU 304, which is typically a processor that includes an arithmetic logic unit (ALU), which performs arithmetic and logical operations, and a control unit (CU), which extracts instructions from memory and decodes and executes them, utilizing the ALU when necessary. An I/O interface may be used to operatively couple the components of processor module 302.

Memory 306 stores programs, which include, for example, a web browser, algorithms, as well as typical operating system programs (not shown), input/output programs (not shown), and other programs that facilitate operation of sponsorship module 208. The web browser (not shown) is for example an Internet browser program such as Internet Explorer™. Memory module 306 may be, for example, an electronic storage medium, such as another electronic storage repository that can store data used by sponsorship module 208. The memory module 306 may include, for example, RAM, ROM, EEPROM or other memory media, such as an optical disk, optical tape, CD, or a floppy disk, a hard disk, or a removable cartridge, on which digital information is stored in the form of bits. The memory module 306 may also be remote memory coupled to processing module 302 via wired or wireless bi-directional communication medium.

Data display module 100 includes memory to store program code and display data that is provided to one or more terminals (202 in FIG. 2). This display data is described in relation to FIG. 1.

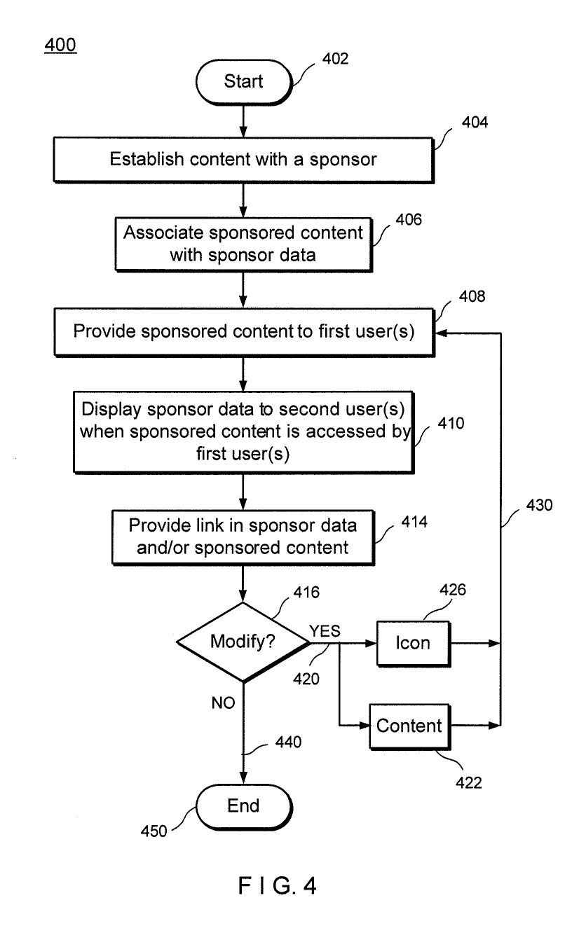

Sponsorship algorithm module 400 is a memory module used to store an algorithm for generating and displaying sponsorship data. This algorithm is described in relation to FIG. 4.

Data display module 500 is a memory module used to store a display data that is provided tone or more users. This display data is described in relation to FIG. 5.

Data display module 600 is a memory module used to store a display data that is provided tone or more users. This display data is described in relation to FIG. 6.

FIG. 4 shows an example of an algorithm used to generate and display sponsorship data according to an embodiment of the present invention. As shown in FIG. 4, the algorithm may be illustrated as a flowchart of steps 400 to implement an embodiment of the present invention. The steps 400 may be executed by a processor, or otherwise executed to perform the identified functions and may also be stored in one or more memories and/or one or more electronic and/or computer-readable media. For example, the steps of FIG. 4 may be stored on a computer-readable medium, such as ROM, RAM, EEPROM, CD, DVD, or other non-volatile memory. The program code stored on an electronic memory medium is a structural element. The process 400 begins with start step 402.

Sponsored electronic content data and/or sponsored articles being sponsored by a third party (sponsor) are established, as shown in step 404. The sponsored content and/or sponsored articles include, for example, video games, CDs, DVDs, demo games, video with alternate endings, bonus video footage, outtakes, bloopers, behind-the scenes interview, plug-ins, plug-and-play, demo material, rental privileges, unlockable content, audio soundtracks, albums, songs, bundles of audio and video content (e.g., 2 movies and 3 music CDs), tangible accessories such as a portable battery pack, headphones or adapter or electronic (virtual) accessories such as accessories for an avatar (e.g., a sword for an avatar, clothing for an avatar), accessories for video games, virtual reality media (VRM) articles, and other virtual articles (such as a virtual clothing article, such as a hat, or virtual weapon such as a sword to be used in another video game) or coupons for other products, such as videos, CDs, DVDs.

The sponsored electronic content and/or sponsored articles are associated with the sponsorship data, as shown in step 406.

The sponsored electronic content data and/or sponsored articles are provided to one or more first users based on predetermined criteria (i.e., inputting a valid voucher code) by the one or more first users, as shown in step 408. Thus the first users are able to utilize the sponsored content.

The sponsorship data is displayed on a display unit associated with one or more second users while the sponsored electronic content and/or sponsored articles is accessed by the one or more first users, as shown in step 410. Thus, the second users can “see” by viewing their display, such as a “Friends List” what other users are playing/using and whether any of the content has been sponsored by a sponsor.

The sponsor data may also include a link that can access a sponsor website or other content, as shown in step 414. The link may be from the sponsored data (icon) and/or the sponsored content.

A determination is made in step 416 whether the sponsor or the sponsored content is to be changed, as shown in step 416. If so, “yes” line 420 leads to either or both of content (sponsored content) changing step 422 and/or icon (sponsorship data) changing step 426. Line 430 then leads to step 408 in which the sponsored content is provided and the process continues. This illustrates that both the sponsor icon, representation, or logo and the sponsored content may be dynamically modified.

If the content and/or sponsorship icon are not changed, “no” line 440 leads to end step 450.

FIG. 5 shows an example of display data including sponsorship data according to an embodiment of the present invention. The display data 500 may be generated at sponsorship module 208 and displayed at a display apparatus coupled to terminals 202 and 206. Display data 500 shows an icon 116 associated with a user for example UserFriend 1 (134). Sponsorship data 162 shows that a game with an accessory (RESISTANCE2™ with weapon pack 1) was provided by a sponsor (Company A) 564.

Display area 504 shows attributes of UserFriend 1, including level (508), percentage (518) and trophies (516). Thus when another user views UserFriend 1, the other user is informed of UserFriend 1's gaming activities and specifically that UserFriend 1 is utilizing sponsored accessories (134) and a representation of the sponsor (564). (As shown in FIG. 5, the sponsor of the content is “Company A” (564), whereas previously (as shown in FIG. 1 the sponsor was User A), thus the sponsoring party may be modified.)

FIG. 6 shows an example of display data including another example of sponsorship data according to an embodiment of the present invention. FIG. 6 shows display screen 600 that includes a pictorial representation 640 and sponsor data 644. The data shown in FIG. 6 is used with a games list on a Xcross Media Bar. The pictorial representation 640 shows a video game PIXELJUNK EDEN™ is sponsored by XYZ Company 644. The sponsorship data 644 is displayed with the video game representation 640.

It will be appreciated from the above that the invention may be implemented as computer software, which may be supplied on a storage medium or via a transmission medium such as a local-area network or a wide-area network, such as the Internet. It is to be further understood that, because some of the constituent system components and method steps depicted in the accompanying Figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

It is to be understood that the present invention can be implemented in various forms of hardware, software, firmware, special purpose processes, or a combination thereof. In one embodiment, the present invention can be implemented in software as an application program tangible embodied on a computer readable program storage device. The application program can be uploaded to, and executed by, a machine comprising any suitable architecture.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

What is claimed is:

1. A method for displaying sponsorship data on a display apparatus comprising:
establishing sponsored electronic content data and/or sponsored articles being sponsored by a third party;
associating the sponsored electronic content and/or sponsored articles with the sponsorship data;
providing the sponsored electronic content data and/or sponsored articles to one or more first users based on predetermined criteria and actions by the one or more first users; and
displaying the sponsorship data on a display unit associated with one or more second users while the sponsored electronic content and/or sponsored articles is accessed by the one or more first users,
wherein the sponsorship data identifies the third party.

2. The method as claimed in claim 1, further comprising:
dynamically modifying the sponsorship data; and
displaying the modified sponsorship data on a display unit associated with the one or more second users while the sponsored electronic content and/or sponsored articles is accessed by the one or more first users.

3. The method as claimed in claim 1, further comprising:
dynamically modifying the sponsored electronic content and/or sponsored articles; and
displaying sponsorship data associated with the modified sponsored electronic content and/or sponsored articles on a display unit associated with the one or more second users while the sponsored electronic content and/or sponsored articles is accessed by the one or more first users.

4. The method as claimed in claim 1, further comprising:
providing a link from the displayed sponsorship data to a website related to the sponsor.

5. The method as claimed in claim 1, further comprising:
establishing a fee schedule for each third party to sponsor the electronic content and/or articles.

6. The method as claimed in claim 1, wherein the sponsored electronic content data and/or sponsored articles includes video games, virtual articles, down-loadable electronic content, electronic items, plug-ins, and audio content.

7. The method as claimed in claim 1, further comprising:
embedding predetermined content in the sponsored electronic content based on the third party.
